(19) United States
(12) Patent Application Publication
(10) Pub. No.: US 2007/0129171 A1
(43) Pub. Date: Jun. 7, 2007

(54) Method for Manufacturing a Golf Product

(76) Inventor: Vincent J. Simonds, Brimfield, MA (US)

Correspondence Address: MICHAEL A. CATANIA;CALLAWAY GOLF COMPANY, 2180 RUTHERFORD ROAD, CARLSBAD, CA, 92008-7328, US

(21) Appl. No.: 11/548,146

(22) Filed: Oct. 10, 2006

Related U.S. Application Data
(60) Provisional application No. 60/725,694, filed on Oct. 12, 2005.

(51) Int. Cl. A63B 37/04; C08F 283/04

(52) U.S. Cl. 473/371; 525/453

(57) ABSTRACT

Methods for controlling the shot volume in a reaction injection molding process for manufacturing a golf product, such as a golf ball or golf ball component, are disclosed. The method comprises measuring the in-mold packing pressure as a reaction mixture is injected into the mold. When the pressure reaches a target value, injection ends. Use of the method results in less waste of reaction mixture and consistent golf product quality.

### CROSS REFERENCES TO RELATED APPLICATIONS

The Present Application claims priority to U.S. Provisional patent Application No. 60/725,694, filed on Oct. 12, 2005.

### STATEMENT REGARDING FEDERALLY SPONSORED RESEARCH OR DEVELOPMENT

Not Applicable

### BACKGROUND OF THE INVENTION

1. Field of the Invention

The present disclosure relates, in various embodiments, generally to a method for controlling the shot volume of a reaction injection molding (RIM) process which produces golf products. It applies particularly to ensuring consistent repeatability of the process, accuracy of material delivery, and consistent part quality.

2. Description of the Related Art

Reaction injection molding (RIM) is a process used by the Applicant to make golf ball components, such as one-piece balls, covers, cores, and inner layers. Highly reactive liquids are injected into a closed mold, mixed usually by impingement and/or mechanical mixing in an in-line device such as a “peanut mixer”, and polymerized primarily in the mold to form a coherent, molded article. When used to make a thermoset polyurethane or polyurea component, RIM usually involves a rapid reaction between two types of reactants: (a) a polyol or other material with an active hydrogen, such as a polyfunctional alcohol or amine (hereinafter referred to as “polyol”); and (b) an isocyanate-containing compound (hereinafter referred to as “isocyanate”). The reactants are stored in separate tanks prior to molding and may be first mixed in a mix-head upstream of a mold and then injected into the mold. The liquid streams are metered in the desired weight to weight ratio and fed into an impingement mix-head, with mixing occurring under high pressure, e.g., 1500 to 3000 psi. The liquid streams impinge upon each other in the mixing chamber of the mix-head and the mixture is injected into the mold; this injection of the mixture into the mold is typically referred to as a “shot”. One of the liquid streams typically contains a catalyst for the reaction. The reactants react rapidly after mixing to gel and form polyurethane or polyurea polymers.

RIM offers several advantages over conventional, injection and compression molding techniques for producing golf products and/or equipment. For example, in the RIM process, the reactants are simultaneously mixed and injected into the mold, forming the desired component. In conventional techniques, the reactants must first be mixed in a mixer separate from the molding apparatus, and then added into the apparatus. In such a process, the mixed reactants first solidify and must later be melted in order to properly mold the desired components, etc.

Additionally, the RIM process requires lower temperatures and pressures during molding than injection or compression molding. Under the RIM process, the molding temperature is maintained from about 90 to about 180° F., and usually at about 110-150F100-120° F., in order to ensure proper injection viscosity. Compression molding is typically completed at a higher molding temperature of about 320° F. (160° C.) while injection molding is completed at an even higher temperature range of 392-482° F. (200-250° C.). Molding at a lower temperature and pressure is beneficial when, for example, the cover is molded over a very soft core so that the very soft core does not melt, decompose or distort during the molding process. In addition, lower molding temperatures reduce the overall molding cycle thereby increasing production throughput.

Moreover, the RIM process creates more favorable durability properties in a golf ball component than conventional techniques. For example, a golf ball cover produced by a RIM process has a uniform or “seamless” cover in which the properties of the cover material in the region along the parting line are generally the same as the properties of the cover material at other locations on the cover, including at the poles. The improvement in durability is due to the fact that the reaction mixture is distributed uniformly into a closed mold. This uniform distribution of the injected materials reduces or eliminates knit-lines and other molding deficiencies which can be caused by temperature differences and/or reaction differences in the injected materials. The RIM process results in generally uniform molecular structure, density and stress distribution as compared to conventional injection molding processes, where failure along the parting line or seam of the mold can occur because the interfacial region is intrinsically different from the remainder of the cover layer and, thus, can be weaker or more stressed.

Furthermore, the RIM process is relatively faster than conventional techniques. In the RIM process, the chemical reaction usually takes place in under 5 minutes, typically in less than two minutes, sometimes in under one minute and, in many cases, in about 30 seconds or less. The demolding time may be 10 minutes or less. The molding process for the conventional methods itself typically takes about 15 minutes. Thus, the overall speed of the RIM process makes it advantageous over the injection and compression molding methods.

The term “demold time” generally refers to the mold release time, which is the time span from the mixing of the components until the earliest possible time at which the part may be removed from the mold. At that time of removal, the part is said to exhibit sufficient “green strength.” The term “reaction time” generally refers to the setting time or curing time, which is the time span from the beginning of mixing until the time at which the product no longer flows. Further description of the terms setting time and mold release time are provided in the “Polyurethane Handbook,” edited by Gunter Oertel, Second Edition, ISBN 1-56990-157-0, herein incorporated by reference in its entirety.

As mentioned above, a “shot” refers to the act of injecting the reaction mixture into the mold; it can also refer to the amount of the reaction mixture injected. A shot is typically a fixed volume of reaction mixture. However, using a fixed volume shot has certain problems, especially on a production line where golf products are repeatedly produced. For example, when the golf ball component to be produced is an outer cover, a core is usually placed within the mold and the outer cover is formed around it. On a production line, such cores will vary in size; however, a fixed volume shot does not compensate for this size variation. In addition, thermal expansion occurs when the core is placed in a heated mold. Again a fixed shot volume does not compensate for thermal expansion particularly when the delay time between core insertion and material injection varies As a result, reaction mixture can be wasted. The resulting golf ball may also fail quality control; for example, the extra reaction mixture may have been forced between the seams of the mold, resulting in a “belt” around the ball that renders it unplayable. The roundness of the outer cover may vary between balls. The thickness of the outer cover could also vary. The overall ball diameter will vary depending on the volume of material injected. Hence, new methods for controlling the RIM manufacturing of golf products, such as golf balls and/or components thereof, are desired.

### BRIEF SUMMARY OF THE INVENTION

Disclosed herein, in various embodiments, are methods for controlling the shot volume of a RIM process. In embodiments, the shot volume is controlled by measuring the pressure within the mold rather than using a fixed volume for the shot. Use of the method results in accurate material delivery and consistent part quality.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 shows a general RIM process flow diagram.

FIG. 2 is an exemplary embodiment of the present disclosure.

### DETAILED DESCRIPTION OF THE INVENTION

A more complete understanding of the methods disclosed herein can be obtained by reference to the accompanying drawings. These figures are merely schematic representations based on convenience and the ease of demonstrating the present disclosure, and are, therefore, not intended to indicate relative size, dimensions, or locations of the apparatuses thereof and/or to define or limit the scope of the disclosure. Although specific terms are used in the following description for the sake of clarity, these terms are intended to refer only to the embodiments illustrated in the drawings, and are not intended to define or limit the scope of the disclosure. In the drawings and the following description below, it is to be understood that like numeric designations refer to components of like function.

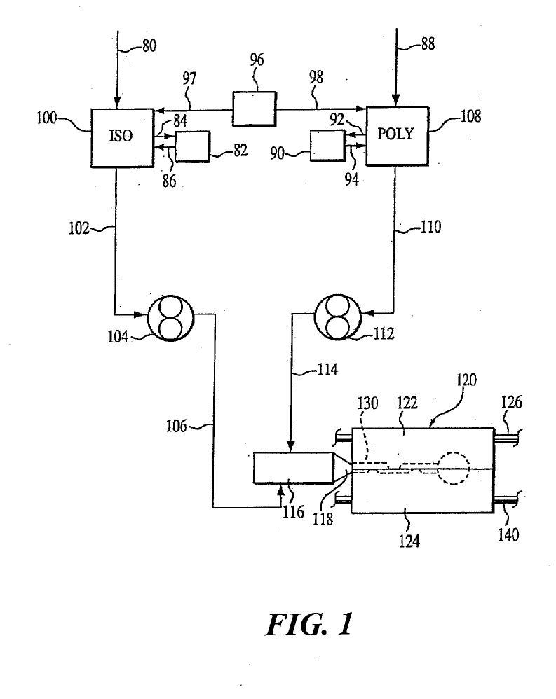

A general overview of a RIM process will aid in understanding the methods of the present disclosure. FIG. 1 shows a general process flow diagram for forming a RIM golf ball cover of polyurethane. Isocyanate from bulk storage is fed through line 80 to an isocyanate tank 100. The isocyanate is heated to the desired temperature, e.g. about 90 to about 150° F., by circulating it through heat exchanger 82 via lines 84 and 86.

Polyol is conveyed from bulk storage to a polyol tank 108 via line 88. The polyol is heated to the desired temperature, e.g. about 90 to about 150° F., by circulating it through heat exchanger 90 via lines 92 and 94. Dry nitrogen gas is fed from nitrogen tank 96 to isocyanate tank 100 via line 97 and to polyol tank 108 via line 98. Isocyanate is fed from isocyanate tank 100 via line 102 through a metering cylinder or metering pump 104 into mix-head inlet line 106. Polyol is fed from polyol tank 108 via line 110 through a metering cylinder or metering pump 112 into mix-head inlet line 114. The mix-head 116 receives isocyanate and polyol streams under pressure, mixes them, and provides for them to be fed through nozzle 118 into injection mold 120. The injection mold 120 has a top mold 122 and a bottom mold 124; together, the top mold and bottom mold define a mold cavity which is filled by the reaction mixture. Mold heating or cooling can be performed through lines 126 in the top mold 122 and lines 140 in the bottom mold 124. The materials are kept under controlled conditions to insure that the desired reaction profile is maintained.

Inside the mix-head 116, the isocyanate and polyol are directed through small orifices, or reducers, at ultra-high velocity to provide excellent mixing. Additional mixing may be conducted using an aftermixer 130, which typically is constructed inside the mold between the mix-head and the mold cavity. The reaction mixture viscosity should be sufficiently low to ensure that the empty space in the mold is completely filled. The mix-head is opened for a period of time and the pressure of the isocyanate and polyol force the reaction mixture into the mold. The mix-head is then closed and the reaction mixture gels and forms a polymer.

Currently, a RIM machine, which implements the RIM process of the present disclosure, controls shot volume by controlling (1) the pressure at which the isocyanate and polyol are injected into the mix-head; and (2) the amount of time for which the mix-head is open and reaction mixture is fed into the injection mold. Generally, the shot volume is controlled by the amount of time for which the mix-head is open, or the “shot time”. This is because the pressures of the reactant streams also affects the mixing of the reactants and hence the quality of the resulting polymer. In addition, the electromechanical reaction time of the mix-head is better than the reaction time of the pumps which create the pressure of the reactant streams. As previously mentioned, the shot time is usually a fixed amount, resulting in a fixed shot volume. In a production run, this means the shot volume for each golf ball component is fixed, even though the required shot volume varies between shots. The methods of the present disclosure allow the shot volume for each shot to vary yet maintain consistent in-mold material packing pressures.

The shot volume for each shot is varied by measuring the in-mold packing pressure rather than the shot time. First, a target for the in-mold packing pressure is established for each shot; this target may also be called the fill pressure.

Next, injection of the reaction mixture into the mold begins. While the reaction mixture is injected, the in-mold packing pressure is measured. In embodiments, the in-mold packing pressure is measured with a pressure transducer, which converts the pressure into an electrical signal. This signal may be sent to an automatic monitoring device, such as a computer, or be displayed to an operator. The signal may be used to control the shot volume by controlling the mix-head. When the in-mold packing pressure reaches the fill pressure, injection of the reaction mixture ends.

In another exemplary embodiment, the shot volume is controlled by controlling the pressures applied to the separate isocyanate and polyol streams. As long as the ratio of the pressures between the two reactants remains constant, the stoichiometry of the two reactants will also remain constant. In this embodiment, the mix-head remains open for a fixed amount of time, but the amount of reaction mixture flowing into the mold changes. The stoichiometry is a function of the material mixing ratio and mixing quality which is a primarily a function of material flow rate (velocity). The material impingement pressures are a result of the required flow rates as long as the system is not pressure limited i.e. the machine will continue to build pressure in order to achieve the commanded flow rate. The commanded flow rate controls the component delivery volume and as a result the stoichiometry.

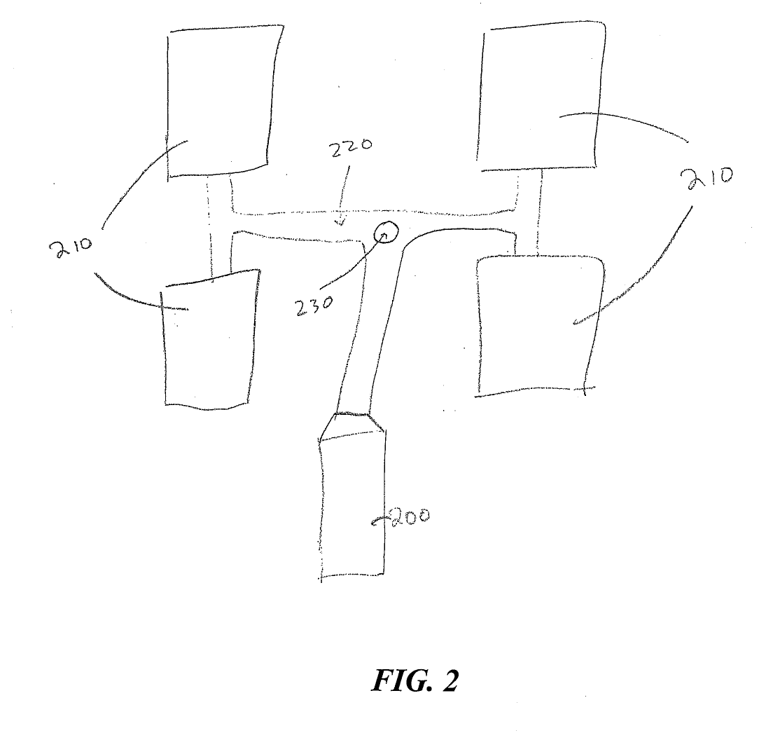

The in-mold packing pressure can be measured directly or indirectly. The in-mold packing pressure can be measured directly by mounting the pressure transducer so that it measures the pressure in the mold cavity. Alternatively, the in-mold packing pressure can be measured indirectly by mounting the pressure transducer so that it measures the pressure along the path from the mix-head into the mold cavity. For example, in an exemplary embodiment, a RIM machine is used to injection reaction mixture into more than one mold in order to maximize productivity. FIG. 2 is a schematic diagram of such an exemplary embodiment. Here, the RIM machine 200 is connected to four separate molds 210 by a common runner 220 which runs to each mold; machinery (not shown) directs the reaction mixture from the RIM machine to the appropriate mold. Here, only one pressure transducer, instead of four, is needed because it is placed at a location 230 in the runner which is shared by all four paths from the RIM machine to a mold.

Any pressure transducer may be used. An example of a suitable transducer is the RJG T-6159 available from RJG, Inc. This pressure transducer may be directly mounted to the mold cavity and has a measuring capacity of from zero to 20,000 psi.

The method may be adapted to vary the density of the golf ball component as well. This may be accomplished by changing the fill pressure to either increase or decrease the shot volume.

As a result of the use of the methods of the present disclosure, a RIM process for producing golf ball components is more repeatable. Less isocyanate and polyol is wasted. The golf ball components produced are of more consistent quality.

Specific embodiments of the disclosure will now be described in detail. These examples are intended to be illustrative, and the disclosure is not limited to the materials, conditions, or process parameters set forth in these embodiments. All parts and percentages are by weight unless otherwise indicated.

### EXAMPLE 1

A mold was equipped with a pressure transducer and golf balls were produced. The peak pressure, shot, and throughput were measured and the data is reproduced in Table 1 below.

TABLE 1

| | | | Throughput | |
|---|---|---|---|---|
| Trial # | Peak Value (psi) | Shot | (g/sec) | Notes |
| 1 | 168 | .620 | 38 | |
| 2 | 216 | | | |
| 3 | 240 | | | |
| 4 | 144 | | | |
| 5 | 144 | | | |
| 6 | 144 | | | |
| 7 | 72 | | | |
| 8 | 96 | | | |
| 9 | 72 | | | |
| 10 | 0 | | | No inserts |
| 11 | 24 | | | 3 inserts |

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as my invention:

1. A method for controlling the shot volume in a RIM process for making a golf product, comprising:
establishing a predetermined fill pressure;
forming a reaction mixture comprising an isocyanate and a polyol;
starting an injection of the reaction mixture into a mold;
measuring the pressure in the mold; and
ending the injection when the pressure reaches the fill pressure.

2. The method of claim 1, wherein the pressure is measured with a pressure transducer.

3. The method of claim 2, wherein the pressure transducer is located in the mold cavity.

4. The method of claim 2, wherein the pressure transducer is located in the runner.

5. The method of claim 1, wherein the injection of the reaction mixture is started or ended by opening or closing the mix-head.

6. The method of claim 1, wherein the reaction mixture is formed by impinging an isocyanate stream and a polyol stream under pressure.

7. The method of claim 6, wherein the injection of the reaction mixture is started or ended by increasing or decreasing the pressure of the isocyanate or the polyol.
